(19) United States
(12) Patent Application Publication
(10) Pub. No.: US 2010/0225084 A1
(43) Pub. Date: Sep. 9, 2010

(54) VEHICLE SUSPENSION SYSTEM

(75) Inventors: Nicholas J. CHAPMAN, Chico, CA (US); Walter KOHLER, Manteca, CA (US)

Correspondence Address: Beyer Law Group LLP, P.O. BOX 1687, Cupertino, CA, 95015-1687, US

(73) Assignee: DARCO TRUST, Stateline, NV (US)

(21) Appl. No.: 12/650,505

(22) Filed: Dec. 30, 2009

Related U.S. Application Data
(60) Provisional application No. 61/203,849, filed on Dec. 30, 2008.

(51) Int. Cl. B60G 21/055; B60G 15/06

(52) U.S. Cl. 280/124.107; 267/221

(57) ABSTRACT

A vehicle suspension or damping system includes a coupling component, a torsion bar, a plurality of lever arms, a fluid based damping device, a coil spring, and an electronically controlled valve-based damping device. The torsion bar converts an external load that is transferred to the torsion bar via the coupling component into a rotational displacement of the torsion bar. Each of the lever arms is adapted to physically move with the torsion bar when said torsion bar experiences a rotational displacement, and each of the fluid based damping device, coil spring and electronically controlled valve-based damping device damps physical movement of its respective lever arm. One or more damping devices can be coupled to each such lever arm. Alternative applications for the disclosed suspension and shock damping systems can include load transferring manufacturing machinery and earthquake damping for buildings and other structures.

### CROSS-REFERENCE TO RELATED APPLICATIONS

This application claims priority to U.S. Provisional Patent Application No. 61/203,849, filed Dec. 30, 2008, and entitled “Suspension/Dampening Device,” which is incorporated by reference herein in its entirety and for all purposes.

### TECHNICAL FIELD

The present invention relates generally to motorized vehicles and other load transferring or bearing devices, and more particularly to suspension systems adapted to damp physical shocks for such vehicles and devices.

### BACKGROUND

As motorized vehicles have developed and evolved over that time, many different advances and improvements have resulted in greater speeds, increased safety, better creature comforts for users and varying aesthetic appearances. One area of advancement has involved the damping of physical shocks or other displacements, such as through the use of shock absorbers and other suspension system components. In ground-based vehicles, for example, such suspension components are typically adapted to damp physical shocks or other displacements between the vehicle wheels and the driver, passengers and/or cargo, such that these latter items do not experience the same drastic physical shock or displacement that is experienced at the wheel to environment interface. Examples of such physical shocks or other displacements include a ground-based vehicle traveling over rough terrain, traveling rapidly over a speed bump, or experiencing a sudden incident outside force, such as an explosion.

While ground-based vehicles provide numerous examples of needs for and implementations of a physical shock damping device or system, it will be understood that other instances exist as well. In fact, many load transferring and/or bearing devices and structures often call for some kind of suspension or other shock damping system. For example, load transferring machinery in manufacturing processes and earthquake safety systems in buildings are additional instances of items that utilize suspension or other physical shock damping systems or measures.

In short, motorized ground vehicles and many other load transferring and bearing items benefit from the use of physical shock damping measures and devices. A common example of such a device is an ordinary automobile shock absorber. Of course, having multiple shock absorbers in a single car increases the physical shock damping for all riders and cargo. Many other types of shock absorbing or damping devices and systems exist, and many such devices and systems essentially apply principles of extending the time period of experiencing and/or otherwise offsetting an incident physical force and/or displacement, such as through various “spring” type components. Such spring components allow an outside force to be experienced over time instead of all at once, such that the overall peak physical shock value is reduced.

While many designs and applications of suspension systems have generally worked well in the past, there is always a desire to provide new and improved designs or techniques that result in better shock damping for vehicles and other load transferring or bearing devices. In particular, what is desired are shock damping systems that are able to accept greater physical shocks and reduce further or eliminate the impact of such shocks to a protected vehicle or other component.

### SUMMARY

It is an advantage of the present invention to provide improved shock damping for motorized vehicles and other load transferring or bearing devices. This can be accomplished at least in part through the use of suspension or shock damping system that includes a torsion bar, a plurality of coupled lever arms, and a plurality of damping components coupled to the lever arms.

In various embodiments of the present invention, a suspension or damping system can include a coupling component, a torsion bar, a plurality of lever arms, a fluid based damping device, a coil spring, and an electronically controlled valve-based damping device. The torsion bar can convert an external load that is transferred to the torsion bar via the coupling component into a rotational displacement of the torsion bar. Each of the lever arms can be adapted to physically move with the torsion bar when the torsion bar experiences a rotational displacement, and each of the fluid based damping device, coil spring and electronically controlled valve-based damping device can damp physical movement of its respective lever arm. One or more damping devices can be coupled to each such lever arm.

In various embodiments, a motorized vehicle suspension system can have a torsion bar adapted to assist in converting a load external to an associated motorized vehicle into a rotational displacement of the torsion bar, a coupling component that couples said torsion bar to a load bearing device on said motorized vehicle, a plurality of lever arms coupled to said torsion bar, wherein each of said plurality of lever arms is adapted to physically move with said torsion bar when said torsion bar experiences a rotational displacement, a fluid based damping device coupled to a first of said plurality of lever arms, wherein said fluid based damping device damps physical movement of said first lever arm, a coil spring coupled to said first of said plurality of lever arms, wherein said coil spring also damps physical movement of said first lever arm, and an electronically controlled valve-based damping device coupled to a second of said plurality of lever arms, wherein said electronically controlled valve-based damping device damps physical movement of said second lever arm.

In various detailed embodiments, the load bearing device can be a vehicle wheel. Also, the fluid based damping device can be an airbag, a hydraulic device, or a combination thereof. In addition, the fluid based damping device and coil spring can be coupled in series to damp physical movement of the first lever arm. Further the motorized vehicle suspension system can be mounted horizontally with respect to the associated motorized vehicle. The motorized vehicle suspension system can also include an external housing adapted to protect the system from outside forces, corrosion and the like.

Alternative applications for the disclosed suspension and shock damping systems can include load transferring manufacturing machinery and earthquake damping for buildings and other structures.

Other apparatuses, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The included drawings are for illustrative purposes and serve only to provide examples of possible structures and arrangements for the disclosed inventive suspension and physical shock damping systems. These drawings in no way limit any changes in form and detail that may be made to the invention by one skilled in the art without departing from the spirit and scope of the invention.

FIG. 1 illustrates in side perspective view an exemplary horizontally mounted assembly for a wheel type suspension module according to one embodiment of the present invention.

FIG. 2 illustrates in side perspective view an alternative exemplary suspension system according to one embodiment of the present invention.

### DETAILED DESCRIPTION

Exemplary applications of apparatuses and methods according to the present invention are described in this section. These examples are being provided solely to add context and aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following examples should not be taken as limiting.

In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting; such that other embodiments may be used, and changes may be made without departing from the spirit and scope of the invention.

The invention relates in various embodiments to a suspension system. In particular, such a suspension system can be adapted to damp physical shocks and/or displacements that are incident to a ground-based motorized vehicle. Further applications of the provided suspension system are also possible, however, and it will be understood that the provided suspension system is not limited to use in ground-based motorized vehicles. Although the present disclosure refers primarily to ground-based motorized vehicles having wheels, such as a “humvee” type of vehicle, it is to be understood that the various inventive elements disclosed herein can also be applied to a wide variety of other vehicle types, such as boats, submarines, planes, rockets or any other vehicle, as may be appropriate. Furthermore, the various inventive elements herein can also be applied to numerous non-vehicular systems, such as load transferring manufacturing machinery and earthquake damping devices for buildings and other structures. In short, the disclosed invention can be applied to any device or system that utilizes damping, suspension or softening for physical shocks and/or displacements, as will be readily appreciated by those skilled in the art.

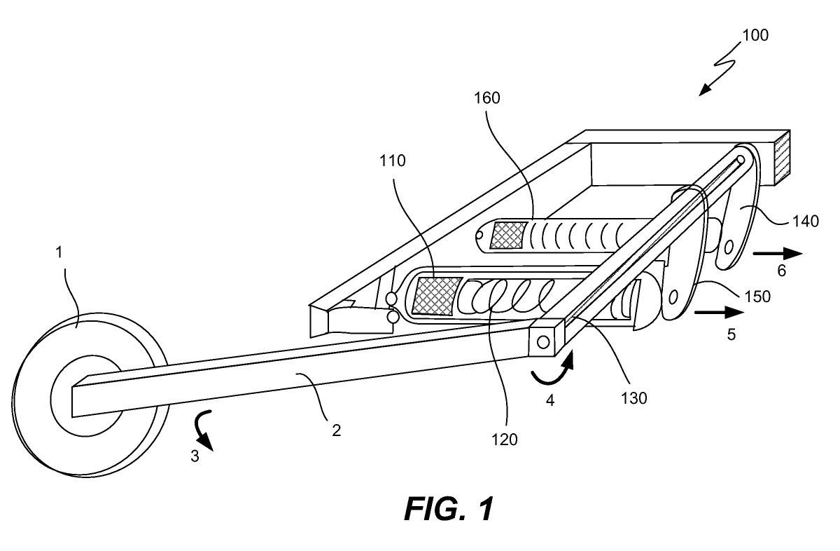

Turning first to FIG. 1, an exemplary horizontally mounted assembly for a wheel type suspension module according to one embodiment of the present invention is illustrated in side perspective view. Suspension system 100 is adapted to damp physical shock and/or displacement to a load bearing device on an associated motorized vehicle, such as wheel 1, that interfaces with an external environment. Physical shocks and/or displacements to wheel 1 are transmitted via a coupling component 2 between the wheel and the rest of the suspension system. Such a coupling component 2 can be a torque arm, for example. Suspension system 100 damps physical shock and/or displacement between wheel 1 and the remainder of the associated motorized vehicle (not shown), so as to provide suspension and support for the vehicle. It will be readily appreciated that suspension system 100 can be used as a front, rear and/or center type suspension for this particular use and application.

Suspension system 100 can include fluid based damping device 110, coil spring 120, torsion bar 130, actuation component 140, lever arms 150 and an additional damping device 160. As shown, torque arm 2 can transmit an outside force, shock and/or physical displacement of wheel 1. This shock or movement 3 to the wheel 1 and torque bar 2 results in a rotational movement 4 of torsion bar 130. Rotational movement 4 in torsion bar 130 then results in accompanying rotation and lateral movements 5, 6 in the plurality of coupled lever arms 150. The plurality of lever arms 150 rotate with the torsion bar 130, which then results in the stretching, displacement or elongation of various damping components 110, 120, 160 that are coupled to the lever arms. While one end of each damping component or series of damping components is coupled to a respective movable lever arm 150, the other end is coupled to a static framework of the suspension module or system.

Fluid damping device 110 can be an airbag, a hydraulic device, or a combination thereof. Various properties of fluid damping device 110 can be adjusted to provide a desired damping result as the device is elongated in response to a rotational movement 4 of the torsion bar 130 and corresponding lateral movement 5 of the lever arm 150 associated with the fluid damping device. Coil spring 120 can be mounted in series or in parallel with fluid damping device 110, such that its damping effect is also realized by its respective lever arm 150 and torsion bar 130. In this manner, one or more damping devices may similarly be mounted in parallel or series with respect to each other to provide damping via a respective lever arm.

Additional damping device 160 can be coupled to a second lever arm 150 that is separate from the lever arm associated with fluid damping device 110 and/or coil spring 120. Additional damping device 160 can be similar to a conventional shock absorber, except that an electronically controlled valve and fluid arrangement can be provided. An electronic control (not shown) can control the fluid porting and actuation of the damping portion of damping device 160, and can be tailored to fit the needs of the spring rate thereof.

The combination of various damping components 110, 120, 160, can work congruently together to establish light, soft loading and repercussion for the overall system. Various arrangements and parameters can be adjusted so that the damping components 110, 120, 160 can act together in parallel or alternatively in series. For example, damping components 110 and 160 can provide initial damping when the torsion bar 130 first starts to rotate, while further travel then engages and depresses the coil spring 120. Given the spring rate and its associated container with a cylindrical shell or the like, the coil spring 120 can be utilized for more action, and then ultimately when bottomed out or in “coil bind” state, transmit through the torsion or flex arm, allowing flex at an appropriate spring rate of the torsion arm itself for its last bit of travel.

The resulting overall suspension effect is to give a smooth, soft damping ride or soft movement initially, more aggressive movement through the coil rate of the coil spring 120 and then finally toward the bottoming out portion torquing the arm to prevent breakage before hitting a bump stop. The suspension is also tied together with the additional damping device 160, which can be electronically fired and/or mechanically activated through various viscosities and valve capabilities. In addition, proper accumulation can give sudden bursts of hydraulic pressure to further accent and enhance the spring rate co-efficiency for the various damping components 110, 120, 160. When fired and controlled by an associated electronic controller, this allows the associated controller to actuate the various damping or suspension components to variable damping and suspension, including that of potential hydraulic damping for earthquake resistance, let alone vehicle applications.

An additional advantage is that overall suspension system 100 can be concealed and protected from harm and abuse, corrosion and the like, thus increasing overall reliability. Such a feature can be provided by way of a suitably strong outer housing (not shown), which can be used to seal in the various suspension system components. In various embodiments, suspension system 100 can comprise a removable and interchangeable module, which can be coupled to a respective vehicle within a suitable port or bay, for example. A removable coupling with the torque arm 2 and wheel 1 may also be provided, as may be desired.

As noted above, various applications for suspension system 100 can be made with respect to a ground-based motorized vehicle. Such a vehicle can be that which is described in, for example, commonly owned and co-pending U.S. patent application No. 12/604,367, entitled “Modular Vehicle And Triangular Truss Support System Therefor,” which is incorporated by reference herein in its entirety and for all purposes. Such a modular vehicle system is particularly suitable for on or off-road applications, such that the vehicle could be deployed as a military, drug running, medivac, firefighting, biochemical threat control, search and rescue, hunting, reconnaissance, command center, outback vehicle, survival camper, strike vehicle, border patrol, personnel transport, fuel or fluid tanker and/or crowd control vehicle, among other uses. The suspension components and system provided herein are considered to be well suited for such a vehicle as provided therein.

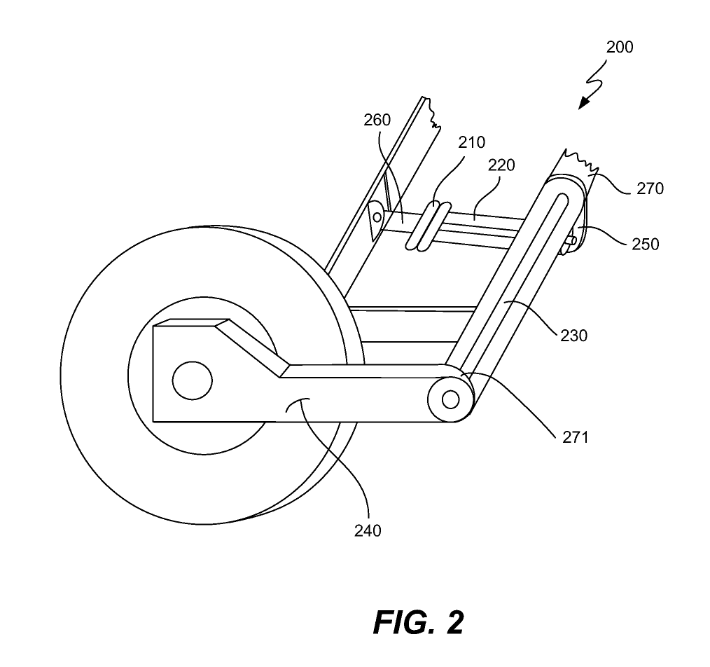

Moving now to FIG. 2, an alternative exemplary suspension system according to another embodiment of the present invention is illustrated in side perspective view. Suspension system 200 can similarly be adapted to provide suspension, damping and support for a vehicular load bearing component, such as wheel 1. Such a wheel 1 or other component to be damped can similarly be coupled via a similar torque arm 240 to a similar torsion bar 230. One or more bushings 270, 271 can aid in coupling and mounting torsion bar 230 to torque arm 240 at or near one end, and one or more housing components, bays, ports or other connectors on the associated vehicle (not shown) at or near the other end.

Unlike the suspension system 100 of FIG. 1, the alternative suspension system 200 of FIG. 2 utilizes a single lever arm 250, with all damping devices 210, 220, 260 being coupled with respect to this single lever arm. Similar to the foregoing embodiments, these damping devices can include a fluid-based damping device 210, such as an airbag or hydraulic device, a coil spring 220, and an additional damping device 260. Again, such an additional damping device 260 can be an electronically controlled valve-based damping device, such as that which is provided above.

Although the foregoing invention has been described in detail by way of illustration and example for purposes of clarity and understanding, it will be recognized that the above described invention may be embodied in numerous other specific variations and embodiments without departing from the spirit or essential characteristics of the invention. For example, although many references have been made with respect to applications of the disclosed suspension systems being ground-based motorized vehicles, applications involving load transferring manufacturing machinery, earthquake damping for buildings and other structures, and numerous other items that require physical shock damping may also be used. Other changes and modifications may be practiced, and it is understood that the invention is not to be limited by the foregoing details, but rather is to be defined by the scope of the claims.

What is claimed is:

1. A motorized vehicle suspension system, comprising:
a torsion bar adapted to assist in converting a load external to an associated motorized vehicle into a rotational displacement of the torsion bar;
a coupling component that couples said torsion bar to a load bearing device on said motorized vehicle;
a plurality of lever arms coupled to said torsion bar, wherein each of said plurality of lever arms is adapted to physically move with said torsion bar when said torsion bar experiences a rotational displacement;
a fluid based damping device coupled to a first of said plurality of lever arms, wherein said fluid based damping device damps physical movement of said first lever arm;
a coil spring coupled to said first of said plurality of lever arms, wherein said coil spring also damps physical movement of said first lever arm; and
an electronically controlled valve-based damping device coupled to a second of said plurality of lever arms, wherein said electronically controlled valve-based damping device damps physical movement of said second lever arm.

2. The motorized vehicle suspension system of claim 1, wherein said load bearing device is a vehicle wheel.

3. The motorized vehicle suspension system of claim 1, wherein said fluid based damping device is an airbag.

4. The motorized vehicle suspension system of claim 1, wherein said fluid based damping device is a hydraulic device.

5. The motorized vehicle suspension system of claim 1, wherein said fluid based damping device and said coil spring are coupled in series to damp physical movement of said first lever arm.

6. The motorized vehicle suspension system of claim 1, wherein said motorized vehicle suspension system is mounted horizontally with respect to the motorized vehicle.

7. The motorized vehicle suspension system of claim 1, further including:
an external housing adapted to protect the system from outside forces or corrosion.

8. A vehicular support system, comprising:
a wheel;
a lever arm coupled to a rotational axis of said wheel; and
a physical shock damping module coupled to said lever arm, wherein said physical shock damping module includes
a torsion bar adapted to assist in converting a load external to an associated vehicle into a rotational displacement of the torsion bar,
a plurality of lever arms coupled to said torsion bar, wherein each of said plurality of lever arms is adapted to physically move with said torsion bar when said torsion bar experiences a rotational displacement,
a first damping device coupled to a first of said plurality of lever arms, wherein said first damping device damps physical movement of said first lever arm, and
a second damping device coupled to a second of said plurality of lever arms, wherein said second damping device damps physical movement of said second lever arm.

9. The vehicular support system of claim 8, wherein said first damping device comprises a fluid based damping device.

10. The vehicular support system of claim 9, wherein said fluid based damping device is an airbag or a hydraulic device.

11. The vehicular support system of claim 8, wherein said second damping device comprises an electronically controlled valve-based damping device

12. The vehicular support system of claim 8, further including:
a third damping device coupled to said first lever arm, wherein said third damping device also damps physical movement of said first lever arm.

13. The vehicular support system of claim 12, wherein said third damping device comprises a coil spring.

14. The vehicular support system of claim 13, wherein said first damping device and said coil spring are coupled in series to damp physical movement of said first lever arm.

15. The vehicular support system of claim 8, wherein said physical shock damping module further includes:
an outer framework coupled to and adapted to support said torsion bar and said first and second damping devices.

16. A physical shock damping system, comprising:
a torsion bar adapted to assist in converting an external load external into a rotational displacement of the torsion bar;
one or more lever arms coupled to said torsion bar, wherein each of said one or more lever arms is adapted to physically move with said torsion bar when said torsion bar experiences a rotational displacement;
a fluid based damping device coupled to a first of said one or more lever arms, wherein said fluid based damping device damps physical movement of said first lever arm;
a coil spring coupled to said first lever arm, wherein said coil spring also damps physical movement of said first lever arm; and
an electronically controlled valve-based damping device coupled to said first lever arm, wherein said electronically controlled valve-based damping device also damps physical movement of said first lever arm.

17. The physical shock damping system of claim 16, wherein said physical shock damping system is adapted to damp physical shocks incumbent upon a vehicle wheel.

18. The physical shock damping system of claim 16, wherein said physical shock damping system is adapted to damp physical shocks incumbent upon a building.

19. The physical shock damping system of claim 16, wherein said physical shock damping system is adapted to damp physical shocks incumbent upon a non-traveling mechanical load bearing device.

20. The physical shock damping system of claim 16, further including:
a coupling component that couples said torsion bar to a load bearing device.
